(19) United States
(12) Patent Application Publication
(10) Pub. No.: US 2024/0311866 A1
(43) Pub. Date: Sep. 19, 2024

(54) SYSTEM AND METHOD FOR CAPACITY MANAGEMENT AND RESOURCE THROTTLING

(71) Applicant: Home & Local Services, LLC, Eden Prairie, MN (US)

(72) Inventors: Thomas A. JOHNSON, Minnetonka, MN (US); Daniel J. MONDELLO, Minnetonka, MN (US); George M. COFFEE, Plymouth, MN (US); Joseph SKAR, Eden Prairie, MN (US); Katherine R. DONOVAN, Chaska, MN (US)

(21) Appl. No.: 18/184,623

(22) Filed: Mar. 15, 2023

Related U.S. Application Data
(63) Continuation of application No. 16/666,379, filed on Oct. 28, 2019, now abandoned.
(60) Provisional application No. 62/751,403, filed on Oct. 26, 2018.

(51) Int. Cl. G06Q 30/0242; G06Q 10/0631; G06Q 10/1093

(52) U.S. Cl. CPC G06Q 30/0244; G06Q 10/06312; G06Q 10/1095

(57) ABSTRACT

Systems and methods for capacity managing and resource throttling are disclosed. An example system can request a plurality of service capacity content parameters from a user and receive the plurality of service capacity content parameters from the user. The plurality of service capacity content parameters can include a service category comprising a service provided by a service provider, a timeframe comprising a number of days, a capacity of potential appointments, and a plurality of input scheduling data comprising a plurality of individual appointments associated with the service category. They system can store the plurality of service capacity content parameters in a database and determine in real-time resource allocation based on the plurality of service capacity content parameters. The system can communicate to a resource allocation platform to adjust a resource activity. The resource activity can be adjusted based upon the generated resource allocation information.

### BACKGROUND

Residential and commercial property service providers often rely on phone-based scheduling. This may be done from a call center where one or more operators has access to a service provider's scheduling system. Customer calls are routed to the call center and the operator facilitates classifying the services needed and proceeds to schedule a service appointment. It may not be efficient in all cases for a service provider to have its own phone operator, so some call centers may operate as contractors to several service providers.

Additionally, some service providers may provide more than one type of service. These may include heating, ventilation, and air conditioning (HVAC), plumbing, electrical, or other services. Because the equipment and skills required for the various services are different, they cannot be treated the same for scheduling purposes. Accordingly, a vehicle staffed by a plumber with plumbing equipment would not be able to properly respond to an electrical service call.

Many service providers advertise in non-static media such as web-based advertising based on the actions of potential customers. One such form of marketing utilizes GOOGLE's ADWORDS whereby a service provider may pay to direct advertising towards persons searching for specific words relevant to the services in areas where the service provider operates. The present system for scheduling services may be used to dynamically adjust the allocation of marketing resources to minimize advertising costs.

### BRIEF DESCRIPTION OF THE DRAWINGS

FIG. 1 is a screen capture of the login page for a web-based portal.

FIG. 2 is a screen capture of the login page for a web-based portal.

FIG. 3 is a screen capture of an administrator page in the web-based portal.

FIG. 4 is a screen capture of an administrator page in the web-based portal.

FIG. 5 is a screen capture of an administrator page in the web-based portal.

FIG. 6 is a screen capture of an administrator page in the web-based portal.

FIG. 7 is a screen capture of an administrator page in the web-based portal.

FIG. 8 is a screen capture of an administrator page in the web-based portal.

FIG. 9 is a screen capture of an administrator page in the web-based portal.

FIG. 10 is a screen capture of an administrator page in the web-based portal.

FIG. 11 is a screen capture of an administrator page in the web-based portal.

FIG. 12 is a screen capture of an administrator page in the web-based portal.

FIG. 13 is a screen capture of an administrator page in the web-based portal.

FIG. 14 is a screen capture of an administrator page in the web-based portal.

### DETAILED DESCRIPTION

The attached drawings show various screens through which administrators and operators may access the system, create appointments, track capacity, and perform other functions. In the drawings, the capacity indicates the number of appointments that may be scheduled for a particular timeframe. In the drawings, this is shown as the number of appointments that can be kept in a given day. The capacity will vary across service categories such as plumbing, HVAC, and electrical depending on the number of equipped vehicles and technicians.

As the number of appointments scheduled approaches the capacity, the advertising activity may be reduced to avoid advertising to customers that ultimately cannot be serviced. This saves on wasted advertising dollars and avoids reputational damage from not being able to accommodate a potential customer.

Throttling of the advertising may be done based on location as well to allow for more efficient scheduling of appointments. This could be done by focusing advertising towards potential customers in areas more easily reached by available technicians.

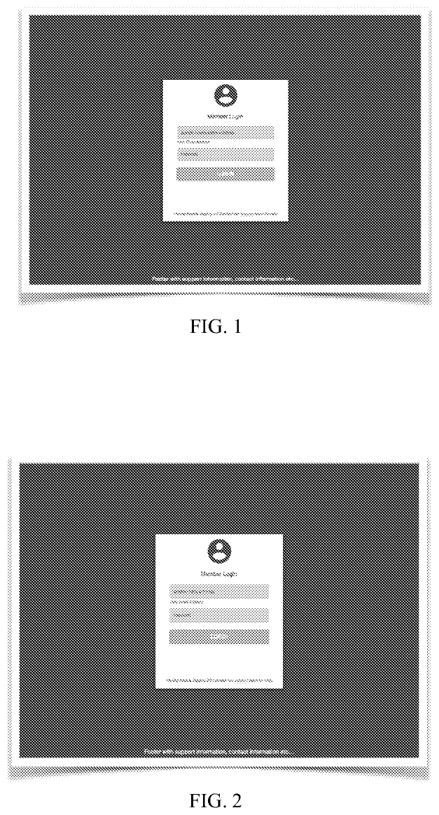

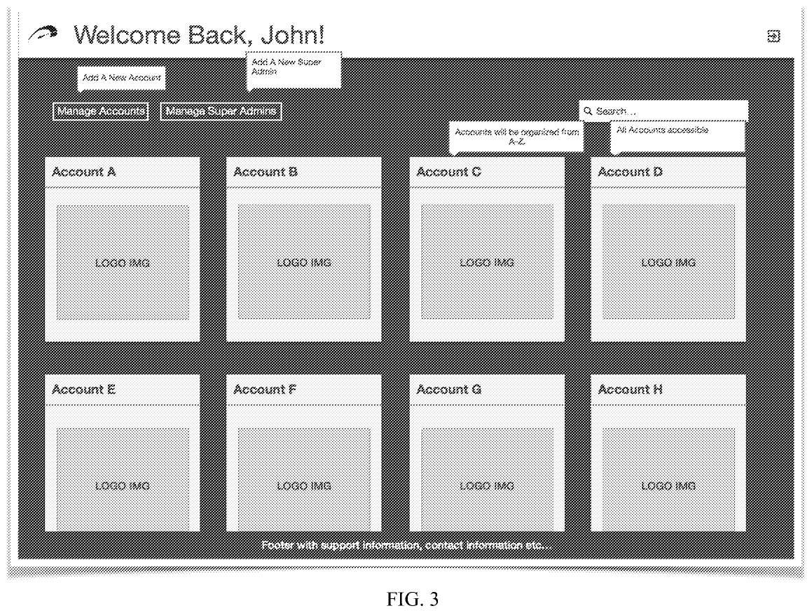

Referring to the figures, FIGS. 1 and 2 show login windows for a web-based service scheduling portal. The login windows are configured for administrators of two levels. A first is a general access administrator who may be employed by or otherwise assist a service provider. General access administrators may schedule service calls within the portal and have read/write/edit privileges within their account. The second administrator type is the super admin. The super admin may be a vendor who provides scheduling services to a number or service providers. When logging in, the super admin will land on a page similar to that shown in FIG. 3 from which the super admin may select an individual account to access. Because a general access administrator will have access only to a single account, they will bypass the page shown in FIG. 3 and land directly on the account page for that account. FIG. 3 may be styles as a Super Admin Dashboard. From this page, a super admin may have access to all Home Service Accounts (i.e., the service provider account managed by a general access administrator). Super Admins can log out, search accounts, manage general access administrator accounts, manage service provider employee accounts, and manage super admin accounts from this screen.

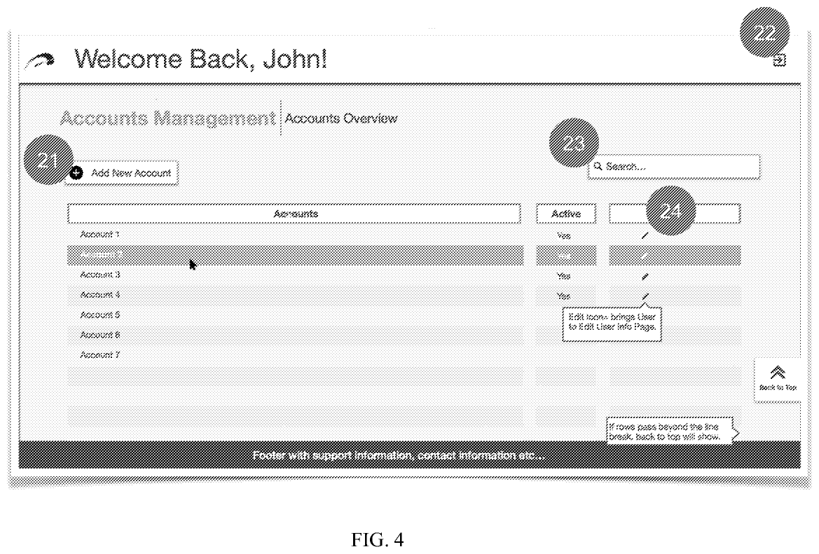

When a super admin selects an account, they will land on a super admin account management page as shown in FIG. 4. Super Admins can “Add New Account” and view all accounts by clicking on icon 21, logout by clicking on icon 22, search accounts using search field 23, or edit an individual account by clicking on one of the edit icons 24.

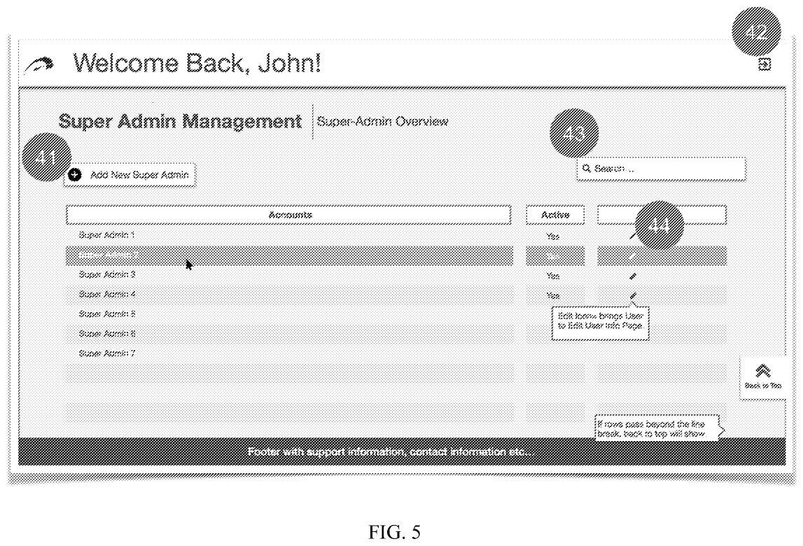

When selecting “Add New Account” by clicking on icon 21, a super admin will be taken to a page as shown in FIG. 5. All of inputs for an account should be treated as required inputs fields. Meaning if an input is not filled in then we should notify the user that they are missing required fields and highlight the missing values. Exemplary features of this page include icons for the following functions: 31 add and edit an account name; 32 add and edit account address, state, city, and zip code; 33 add and edit account phone number; 34 change account time zone via drop down; 35 paste company logo via URL string in open text field; 36 save changes; 37delete an account; 38 go back to account overview via breadcrumbs; and 39 log out.

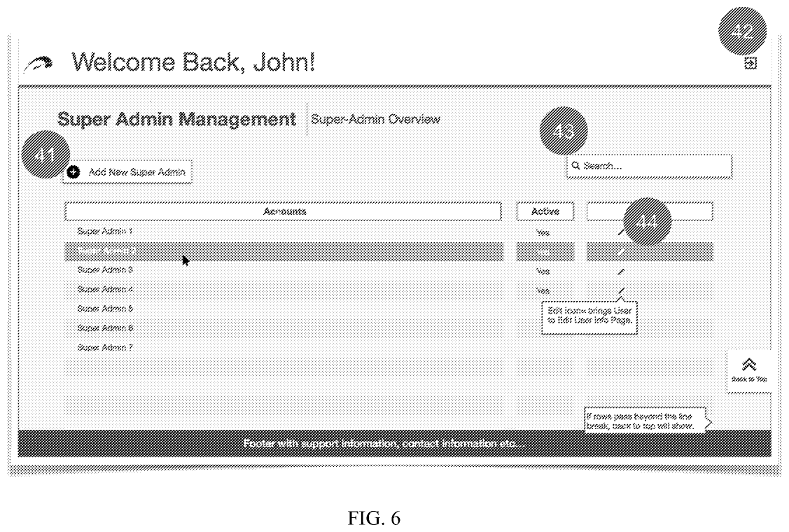

When clicking the “Manage Users” button on the super admin dashboard screen, the user will land on the user management overview screen shown in FIG. 6. Exemplary features of this page include icons for the following functions: 41 super admins can “Add New User/Super Admin” and view all other super admins; 42: super admins can log out; 43 super admins can search accounts; 44 super admins can edit an individual account.

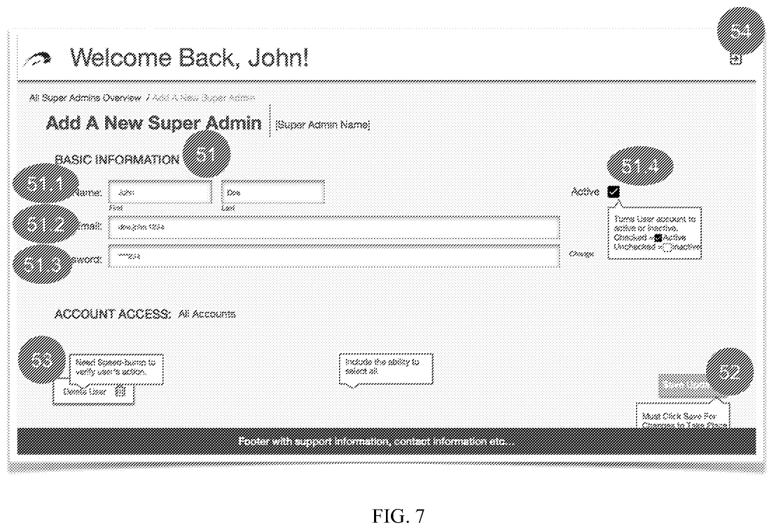

When clicking the “Add new user” button from the user management screen on FIG. 6, the user will be brought to an add new super admin user screen shown in FIG. 7. Clicking Save Updates will add the new user with all the information filled out in the inputs. When clicking to edit a super admin user from the user management screen on FIG. 6 a user will be brought to this same screen except the title will be “Edit User” and the user's details will be pre-populated into the inputs. Clicking save updates will update the user information. All of inputs for a user should be treated as required inputs fields. Meaning if an input is not filled in then we should notify the user that they are missing required fields and highlight the missing values. Exemplary features of this page include icons for the following functions: 51 required user information may be input, including (51.1) user name (first and last), (51.2) email address, (51.3) password, and (51.4) active/inactive status. Additionally, a user may 52 save user information; 53 delete a user; and 54 log out.

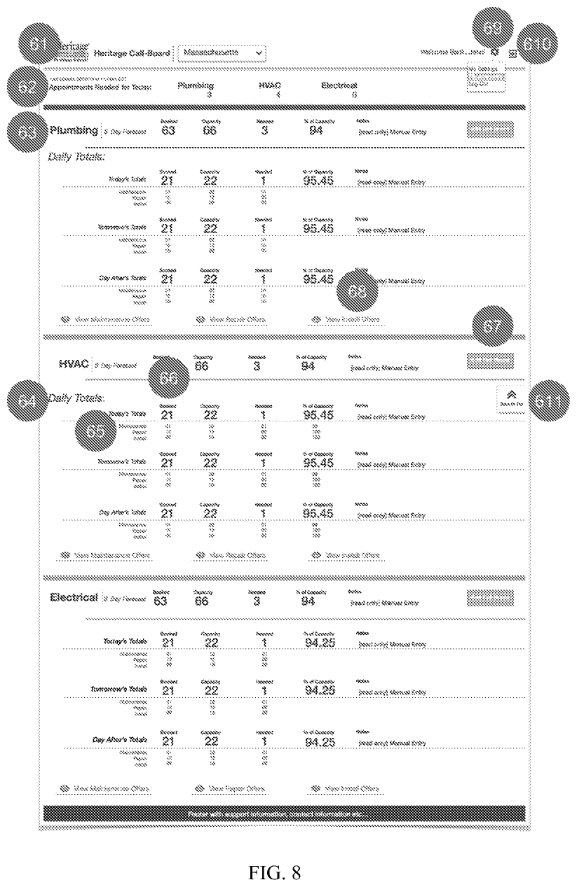

When clicking on an account in the super admin dashboard page or when a general user for this account logs in they will be brought to the account overview page shown in FIG. 8. This page may include a feature 61 to view ‘Last Updated’ timestamp; 62 view ‘Appointments Needed’ for the day; 63 view 3 day forecast of appointments booked, capacity, needed,% of Capacity and a notes field. Feature 64 allows a user to view ‘Daily Totals’ for today, tomorrow, and the next day. Feature 65 allows a user to view a subcategory or service type data such as maintenance, repair, and/or install. Feature 66 provides daily data including appointments booked, capacity, needed, % of capacity and a notes field. Feature 67 permits an administrator to edit individual call boards. Feature 68 allows a user to view a featured offer or service advertisement via hyperlink.

A drop down menu includes a feature 69 to allow a user to go to settings including an account settings page and to “My Accounts” to view the accounts dashboard page. Feature 610 allows the user to log out from this screen and feature 611 scrolls ‘Back To Top’ of the page.

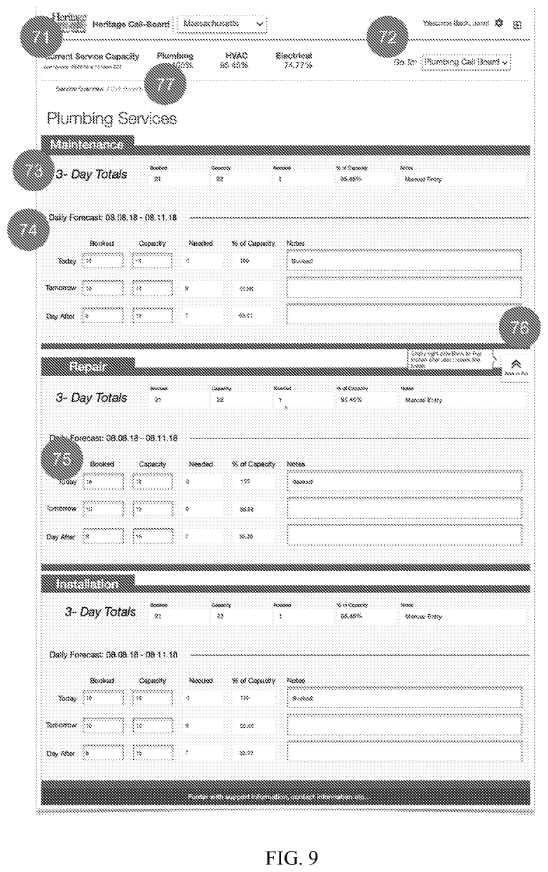

FIG. 9 shows a call board screen. Features include 71 view ‘Current Service Capacity’ to show the amount of unscheduled appointment times. A user may toggle between multiple call boards for an account via drop down menu 72. Feature 73, view 3-day totals, shows appointments booked, capacity, needed number of appointments, % of capacity and notes for each sub-category (i.e., maintenance forecast, repair forecast, and/or install forecast). Feature 74, “View ‘Daily Totals” data including number of appointments needed, and % of capacity. Feature 75 allows the user to edit ‘Daily Totals’ data including the number of appointments booked, capacity and notes. Feature 77 may be used to go back to the overview screen via breadcrumbs.

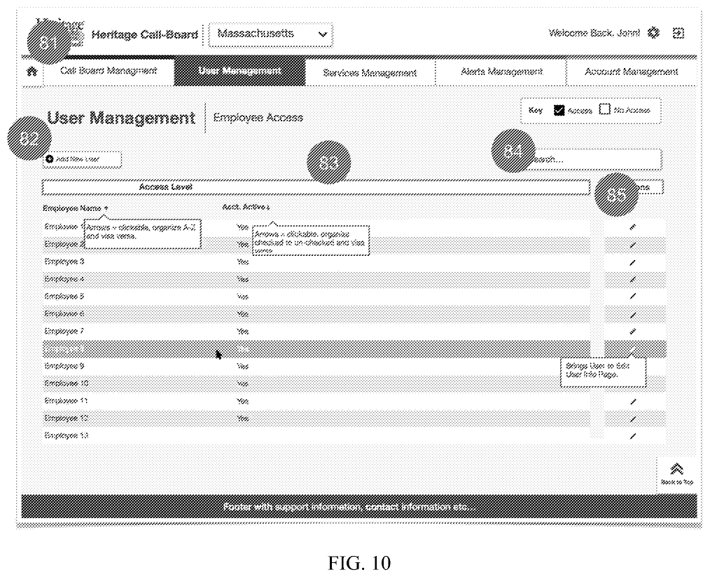

FIG. 10 shows a user management page. When clicking the account settings option in the gear icon menu in the top right, an administrator will be brought to this screen. This user management page will show all general users or employees in this account. The user may use feature 81 to toggle between: call board, user management, service management, alerts management, and account management. feature 82 may be used to add a new employee/general user for this account. feature 83 allows a user to view employee names and active/inactive status. An administrator may use feature 84 to search for specific employees, and feature 85 to edit employee info.

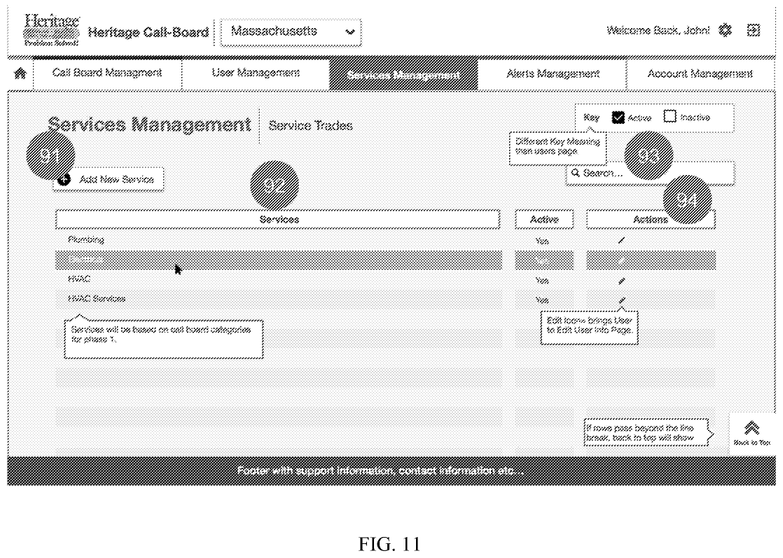

FIG. 11 shows a service management screen. When clicking the services management tab you will be brought to this screen. Each service will by default have 3 active sub categories also known as service types of install, maintenance, and repair in the database. In the future we will be adding the ability to activate or inactivate each service type per service in the UI, but for now the service types for each service will be active and will only be stored in the database. Feature 91 may be used to add a new service. Feature 92 allows a user to view service names, active status and editing (actions) capabilities. Feature 93 allows for a search for specific services, and feature 94 may be used to edit service information.

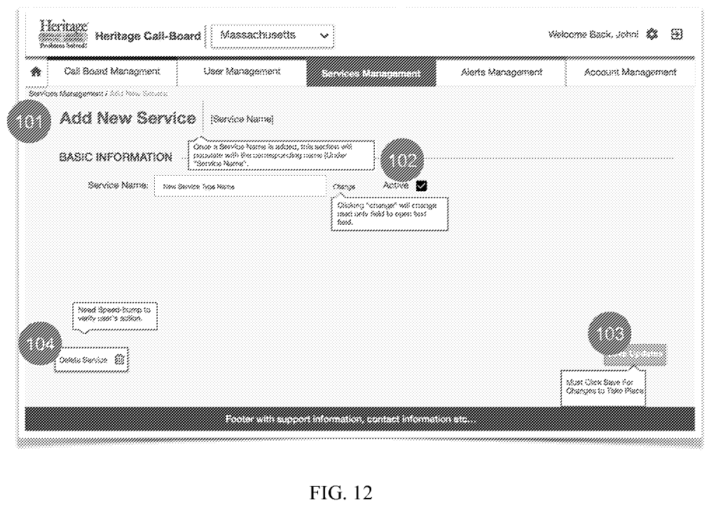

FIG. 12 shows a page on which to add a new or edit and existing service associated with an account. When clicking the add new service button in FIG. 10, a user will be brought to the add new service screen. Clicking save updates 103 will add a new service to this account. When clicking to edit a service from the previous screen you will be brought to this page but the title will say “Edit Service” where title 101 is, and the inputs will be pre-filled out with the service info. Clicking the save updates 103 will update the service information. All Service inputs should be treated as required fields. Meaning if someone clicks the save updates button and there is an input that is not filled out then we will notify the user in UI that they are missing required fields and will highlight the inputs that are missing values. Feature 102 may be used to view and edit: service names and active status feature 104 may be used to delete a service from an account.

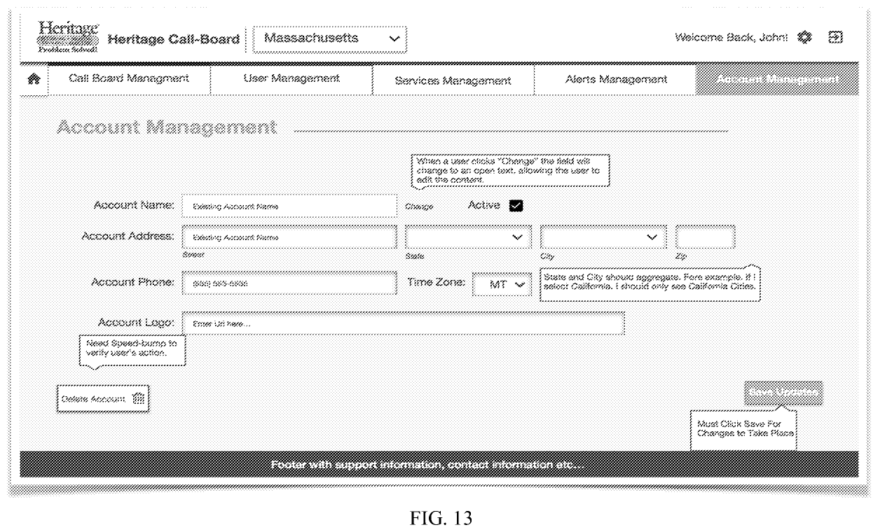

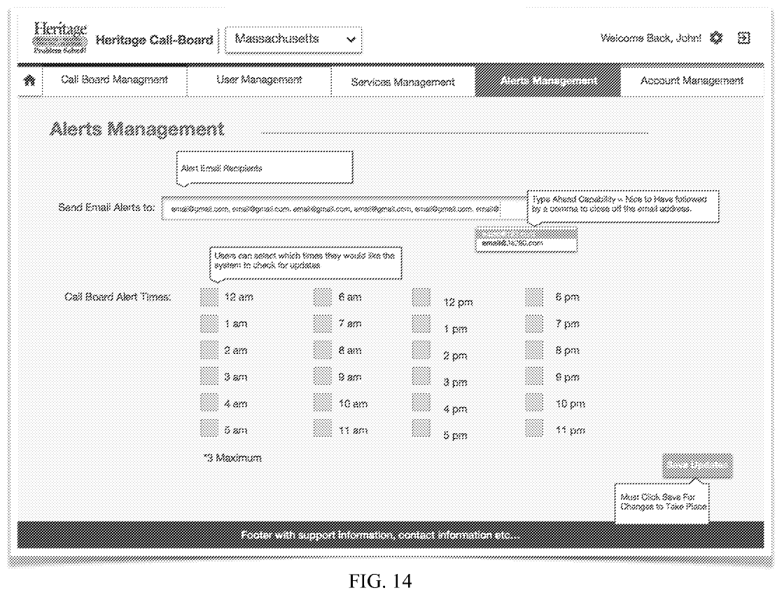

FIG. 13 shows an account management screen for adding/editing account details. When clicking the edit account button from the super admin accounts overview screen the user will be brought to this screen. All of inputs for an account should be treated as required inputs fields. Meaning if an input is not filled in then we should notify the user that they are missing required fields and highlight the missing values. A new account may be created or an existing account modified using the following exemplary fields: account name; account address, sate, city, and zip code; and account phone number. A company logo may be added via URL string in open text field, and an account time zone via drop down.

FIG. 14 shows an alerts management page where a user can manage how and when they receive alerts. Alerts may be sent to email addresses at specified items. The alerts may include scheduling data including appointments booked, capacity, percentage of capacity, or other data.

The system allows for a service provider to, in real time, adjust its advertising spending. Advertising purchase information may be determined by the time left to fill open appointments and the number of appointments needed, capacity, and other data. A communication module may be provided to communicate the advertising purchase information to an advertising platform whereby the service provider may purchase more or reduce its ordered placement of web-based advertisements.

1. A computer implemented method of allocating and optimizing advertising resources, the method comprising:
providing, by a computer system, a web-based user interface module to a user comprising a plurality of user interface windows,
wherein the plurality of user interface windows are configured to request a plurality of service capacity content parameters from the user, and
wherein the plurality of windows are configured to display a plurality of output information content;
receiving, by the computer system, the plurality of service capacity content parameters from the user, the plurality of service capacity content parameters comprising:
a service category comprising a service provided by a service provider;
a timeframe comprising a number of days;
a capacity of potential appointments, wherein the first capacity of potential appointments comprises a maximum number of appointments that may be filled for the service category within the first timeframe; and
a plurality of input scheduling data comprising a plurality of individual appointments associated with the service category;
storing, by the computer system, the plurality of service capacity content parameters in a database;
determining, by the computer system in real time, resource allocation information based on the plurality of service capacity content parameters; and
communicating, by the computer system, to a resource platform to adjust a resource activity, wherein the resource activity is adjusted based upon the determined resource allocation information.

2. The method of claim 1, wherein the plurality of user interface windows further comprise a log-in credential verification window, a super administrator dashboard window, an account management window, a super admin management window, an user management overview window, an add new super admin window, an account overview window, a plurality of callboard windows, a user management window, a service management window, an add new service window, an account management window, and an alerts management window.

3. The method of claim 1, wherein the generatingdetermining, by the computer system, the resource allocation information further comprises:
identifying, by the computer system, a needed number of scheduled appointments within the timeframe, wherein the needed number of scheduled appointments within the timeframe is based on the plurality of service capacity content parameters.

4. The method of claim 3, wherein the identifying, by the computer system, the needed number of scheduled appointments within the timeframe further comprises:
determining, by the computer system, a first individual appointment associated with the service category; and
determining, by the computer system, a second individual appointment associated with the service category.

5. A computer-implemented system for capacity, throttling and call board management for home and local service providers, the system comprising:
a computer memory and processor configured to:
present user controls and accept input through a multi-screen user interface, at least one screen configured for call board management;
accept, save, and present scheduled appointments;
track capacity comprising a maximum number of appointments within range on a given day based on a number of available technicians;
present to a user at least one management page configured to control future email alerts that comprise at least percentage of capacity;
accepting the following throttle inputs:
location of a new appointment for scheduling;
time left to fill the new appointment; and
capacity for new appointment scheduling;
providing a real time resource adjustment throttle;
using the throttle and the throttle inputs, determining an output for resource allocation information; and
providing a communication module configured to use the output from the throttle to communicate with an external resource platform to increase or reduce future orders for web-based resource deployment.

6. A computer-implemented method for throttling a display of second resource data relative to first resource data, the method comprising:
receiving the first resource data associated with a first service provider configured for display on a user interface of a client computing device;
receiving the second resource data associated with a second service provider on the user interface;
receiving a first capacity of appointments associated with the first service provider;
receiving a second capacity of appointments associated with the second service provider;
determining that the first capacity of appointments associated with the first service provider is smaller than the second capacity of appointments associated with the second service provider;
determining a location associated with the client device; and
based at least in part on the determination that the first capacity of appointments associated with the first service provider is smaller than the second capacity of appointments associated with the second service provider and on the determination of the location associated with the client device, throttling the display of the second resource data relative to the first resource data.
